(19) United States
(12) Patent Application Publication
(10) Pub. No.: US 2001/0021428 A1
(43) Pub. Date: Sep. 13, 2001

(54) VACUUM DRYING DIAPHRAGM FILTER PRESS PLATES

(76) Inventors: DAN SIMPSON, RIO VISTA, CA (US); GREGG CROCCO, RIO VISTA, CA (US)

Correspondence Address: LARRY D. JOHNSON, 175 N. REDWOOD DRIVE, SUITE 130, SAN RAFAEL, CA, 94903, US

(21) Appl. No.: 08/981,761

(22) PCT Filed: Jun. 19, 1996
(86) PCT No.: PCT/US96/11470

§ 371 Date: None

(51) Int. Cl. B32B 1/06

(52) U.S. Cl. 428/36.5; 428/71; 428/137

(57) ABSTRACT

A filter press plate (10) having a one piece outer shell (26), rotationally molded out of cross-linked polyethylene, providing an inner cavity filled with a structural polyurethane foam core (24), wherein the outer shell (26) and inner core (24) are adapted to delaminate so that in the filtration area the shell can be expanded out by pressurizing the inner core (24) with a fluid.

### BACKGROUND OF THE INVENTION

### Description

1. Technical Field

This invention relates generally to filter press plates, and more specifically to an improved vacuum drying diaphragm-type filter press plate.

2. Background Art

There are many manufacturers of recessed filter plates and diaphragm filter plates on the market. Standard diaphragm plates are manufactured by placing an elastomer cover over a solid plastic core. The solid plastic core contains the individual drain channels and the corner drain piping. The elastomer covers the filtration area of the plate and is inflated with a fluid introduced through a pipe fitting in the core of the plate. The advantages of a diaphragm plate are: shortened cycle times, better cake washing, and the ability of the press to take variable feed loading.

Disadvantages of current diaphragm plates are many. The main reason diaphragm plates are not used exclusively in the filter press market is cost. The current method of manufacture is very expensive and requires a large capital cost for equipment. A diaphragm plate will usually cost four times that of a standard recessed plate. In addition to the initial cost the two piece construction (elastomer diaphragm and solid plate body) will have higher failure rate due to separation of the pieces. Failure of the elastomer diaphragm itself can also occur.

At least one manufacturer of diaphragm plates has suggested that a hot or cold liquid can be pumped into the core area. This is primarily used to preheat or precool the plate and diaphragm to stay within the material temperature limitations of the part, and not to actually transfer heat to or from the material being filtered.

A non-diaphragm teflon plate with steam coils in the plate has also been proposed. This was to heat and dry the cake solids after the filtration cycle was complete. This approach is problematic because after any initial drying the filter cake loses volume and creates a gap between the cake and the filter press plate. This gap insulates the cake, and heat transfer and drying are limited only to applications where the cake remains in contact with the hot plate surface. Another manufacturer has tried to rotationally mold an outer shell and foam fill the inner section. However, it is difficult to manufacture a continuous outer shell out of crosslink polyethylene, and incorporate drain ports from the filter area to the drain links.

### DISCLOSURE OF INVENTION

The filter press plate of this invention can be distinguished from any other commercial filter plate in physical differences and in functional differences. As opposed to a standard diaphragm plate that has an exposed core with an elastomer diaphragm covering the filtration area, the inventive plate is rotationally molded in one sealed hollow piece. The shell is placed in a second mold and urethane foamed under pressure. This results in a solid core inside the shell that can support the pressures from the press closure and the filtration pressures.

Because no other plate is rotationally molded, no other plate is made from cross linked polyethylene. The crosslinked other shell allows the plate to handle much higher temperatures than the propylene plastic plates currently available.

The inventive plate also has multiple pipe fittings molded into the shell. The pipe fittings allow the hot or cold fluid to be pumped into the core area to heat the shell.

The filter press plate functions like no other available plate. This is primarily due to its one piece cross link polyethylene shell and urethane core. As a conventional diaphragm plate, the one piece outer shell cannot separate in the filtration area because there is no joint or connection point. The cross linked polyethylene is not an elastomer and is much tougher and allows higher filtration temperatures.

Because the shell is a thin sealed crosslinked piece, this allows heat transfer from any fluid pumped into the core to the filter cake. The heating fluid inflates the diaphragm and maintains contact with the cake as the cake loses volume during the drying process under vacuum.

### BRIEF DESCRIPTION OF THE DRAWINGS

FIG. 1 is a perspective view of a complete rotomolded filter press plate of this invention, without cloths.

FIG. 2 is a cutaway perspective view of a filter press plate of this invention.

FIG. 3 is a side elevation cross-sectional view of a filter press plate of this invention, showing the foamed core and outer shell.

FIG. 4 is an elevation view of a pipe fitting molded into the crosslinked shell, used to introduce or remove fluids form the core area.

### BEST MODE FOR CARRYING OUT THE INVENTION

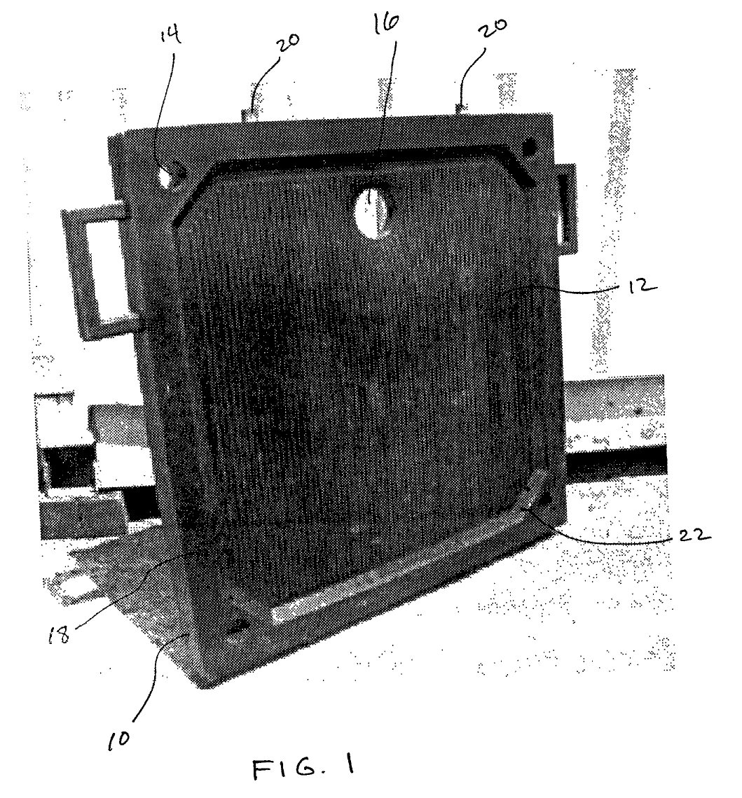

FIG. 1 is a perspective view of a complete rotomolded filter press plate 10 of this invention, without cloths. Filtration area 12 of the plate is ribbed to allow filtrate to flow to the four corner drain ports. This is also the area that delaminates from the core when core pressure is applied and diaphragms out. Heat transfer to the cake occurs in this area. Drain porting 14 allows filtrate to leave each plate and flow to the fixed end of the press to exit. Sludge is pumped to each plate cavity through feed port 16, and is contained by sealing edge 18 of the plate. Molded in pipe fittings 20 allow fluids to be introduced or removed from the plate core (bottom connections not shown). Molded in drain passages 22 allow filtrate to get to the drain ports.

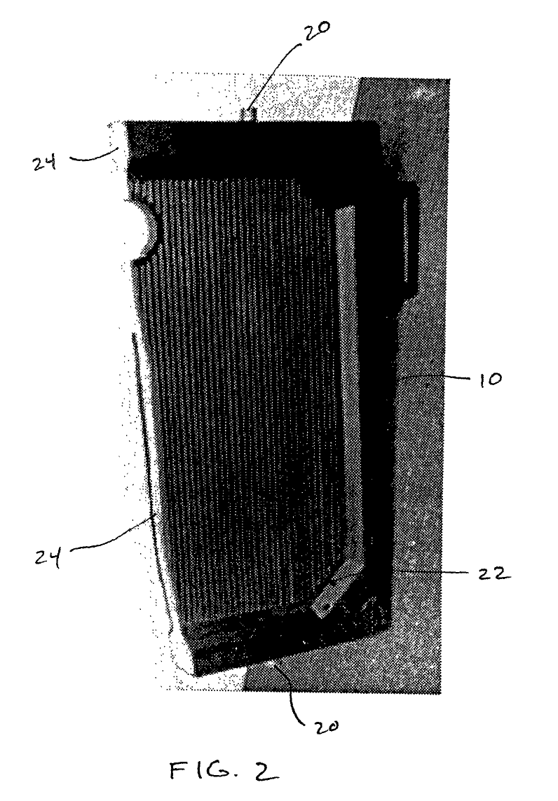

FIG. 2 is a cutaway perspective view of a filter press plate 10 of this invention, illustrating the solid foam core 24 of the plate, drain passages 22, and molded in pipe fittings 20.

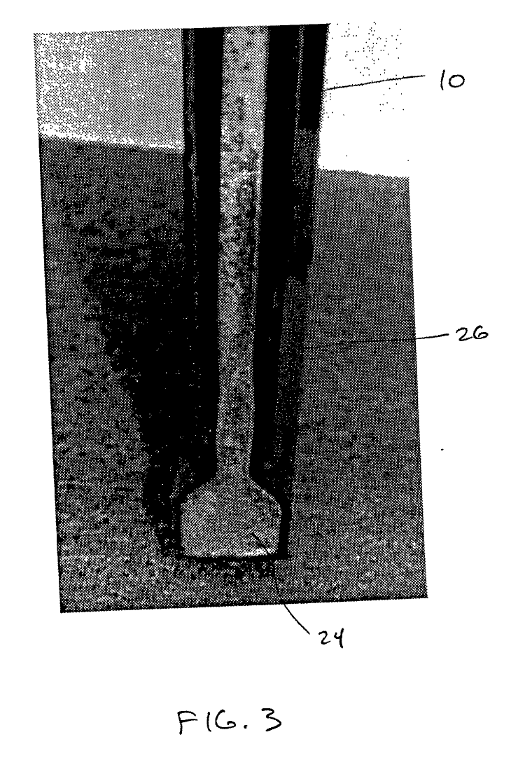

FIG. 3 is a side elevation cross-sectional view of filter press plate 10 of this invention, showing the foam core 24 and outer shell 26.

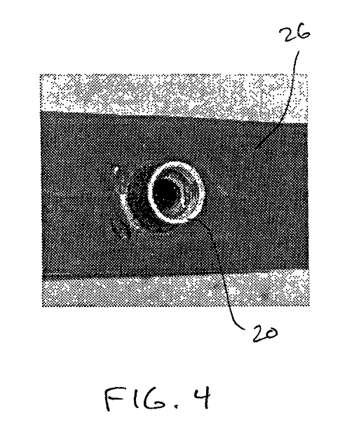

FIG. 4 is an elevation view of a pipe fitting 20 molded into the crosslinked shell 26, used to introduce or remove fluids form the core area.

The invention provides a one piece outer shell, diaphragm recessed filter press plate. The outer shell is rotationally molded out of cross linked polyethylene. The inner cavity is filled with a structural polyurethane foam. The outer shell and the inner core foam delaminate so that in the filtration area the shell can be expanded out by pressurizing the inner core with a fluid. This expanding of the outer shell makes the plate a diaphragm filter press plate. Conventional diaphragm plates utilize an elastomer diaphragm fitted to a solid plastic core. This design is not one piece and fails when the diaphragm separates from the core.

In the rotomolding of the shell, internal drain passages are molded into the shell with pin inserts that are removed prior to opening the mold. This leaves molded in drain pipes that do not compromise the sealed shell of the part.

This invention provides the ability to pump hot or cold fluids into the core area of the plate. Metal pipe inserts are molded into the outer edge of the one piece shell during the manufacturing process. Fluids pumped into the sealed core area heat or cool the shell of the plate. This in turn heats or cools the filter cake held inside each plate cavity. In the case of heating, hot fluid is pumped through the shell under pressure. While the filter press is still in the closed position, a vacuum is pulled on the filter cake through the filtrate drain lines. Under reduced pressure moisture or other volatile materials will vaporize out of the cake. The heat of vaporization is supplied by the heat transfer from the hot fluid through the shell. The vacuum allows drying and heat transfer at a temperature compatible with the plastic materials used in the part. The pressure to expand the diaphragms is supplied by the heating fluid. As the filter cake dries it loses volume and could loose contact with the plate shell thus stopping heat transfer. The diaphragm operation of the plate allows the heat transfer surface to expand as the cake shrinks. This maintains good heat transfer through out the drying cycle.

The inventive process vacuum dries by transferring heat to the filter cake to supply the heat of vaporization through the membrane or diaphragm part of the plate from the circulating hot water. Vacuum is supplied to the filter cake side of the press plate through the filtrate drain lines to lower the boiling point of the liquids in the cake so that there will be enough of a temperature differential between the hot water in the diaphragm area and the cake to get sufficient heat transfer for drying.

Each plate is ported with molded in fittings to allow the hot water to be circulated through the inside of the plate. The internal flow path is between the core of the plate and the diaphragm. The circulation rate is sufficiently high to create turbulence for uniform heating. An external water tank is heated and pumped to a manifold along the bottom of the press. This manifold is hosed to each plate to supply hot water. The top of each plate is hosed to a return manifold that returns the hot water to the tank. Back pressure is maintained on the return manifold to inflate the diaphragms and maintain contact with the cake.

After cake is made and filtrate is no longer exiting the press, the drain lines are connected to the vacuum source. For example, vacuum can be supplied by a liquid eductor, wherein water is circulated through a liquid eductor that pulls a vacuum on the filter press. Vaporized liquids can be condensed by direct contact in the eductor, or in an exchanger prior to the eductor. Vacuum is maintained by cooling the circulating water stream. Vacuum can be supplied through any one of many means.

Hot water can be manifolded as above, or can be supplied through internal plate porting as are feed and drain lines. Vacuum can be supplied by any means. The heating medium could be any fluid. Other core and diaphragm materials could be utilized that could withstand live steam or some other hot fluid.

Wastes can be dried beyond what can normally achieved with standard dewattering devices. Liquids in the void spaces between solid particles in the cake can be removed through vaporization, thus reducing the weight and volume of the waste to be disposed of. In some cases other contaminates can be removed with the primary liquid stream that will help in the disposal options. An example of this is the benzene in A.P.I. wastes that limit land fill options. The low level benzene will azeatroph with the water in the drying process.

Products that need to be supplied in a dry form for sale or for further processing can be dried in the filter press. This would include things like pigments, metals and metal salts, foods and pharmaceuticals. Because the drying is done under vacuum temperature degradation will not occur.

Sewer sludge disposal is limited by the level of pathogens and by the level of moisture in it. Standard dewatering methods cannot meet either requirement with out further treatment. The inventive process can meet 503 regulations for pathogen kill and solids content. The pathogen kill is accomplished by heating the cake with the circulating hot water in the diaphragms without the vacuum. The cake could also be heated by introducing a hot fluid into the cake area. After the temperature and time requirements are met, the vacuum is turned on and the cake is dried to meet the percent solids requirements. The inventive process can also be used if the sludge is being incinerated, because enough water is removed to make the sludge a positive heat value.

In an alternate embodiment, instead of the hot fluid circulation and separate vacuum system to dry the filter cake, a vapor recompression internal heat pump system could be used. After cake is made in the press, a vacuum pump/compressor is used to pull a vacuum on the cake side of the press. These vapors are recompressed to a pressure high enough to inflate the diaphragms of the plates and are introduced to the core area of the plate to supply the heat of vaporization to vaporize more liquid from the cake. In order not to exceed the temperature limitations of the plate, a non-condensable gas is introduced in the recompressed gas stream to lower the dew point of condensing temperature of the stream.

What is claimed as invention is:

1. A filter press plate comprising:
one piece outer shell, diaphragm recessed filter press plate, said outer shell rotationally molded out of cross linked polyethylene, providing an inner cavity filled with a structural polyurethane foam core, wherein said outer shell said inner core are adpated to delaminate so that in the filtration area the shell can be expanded out by pressurizing the inner core with a fluid.

2. The filter press plate of claim 1 including internal drain passages molded into the shell with pin inserts that are removed prior to opening the mold.
